(19) United States
(12) Patent Application Publication
(10) Pub. No.: US 2007/0277023 A1
(43) Pub. Date: Nov. 29, 2007

(54) Method For Switching Over Between At Least Two Operating Modes Of A Processor Unit, As Well Corresponding Processor Unit

(76) Inventors: Reinhard Weiberle, Vaihingen/Enzn (DE); Bernd Mueller, Gerlingen (DE); Ralf Angerbauer, Schwieberdingen (DE); Rainer Gmehlich, Ditzingen (DE); Stefan Benz, Filderstadt (DE)

Correspondence Address: KENYON & KENYON LLP, ONE BROADWAY, NEW YORK, NY, 10004, US

(21) Appl. No.: 10/560,962

(22) PCT Filed: Jun. 22, 2004
(86) PCT No.: PCT/DE04/01299

§ 371 Date: Dec. 21, 2006

(30) Foreign Application Priority Data
Jun. 24, 2003 (DE) 103 28 208.4
Jul. 18, 2003 (DE) 103 32 700.2

(51) Int. Cl. G06F 9/00

(52) U.S. Cl. 712/229

(57) ABSTRACT

A method for switching over between at least two operating modes of a processor unit, having at least two execution units is provided, in which method a change from a first operating mode to a second operating mode is triggered by the processor unit accessing a predefined memory address.

### FIELD OF THE INVENTION

The present invention relates to a method for switching over between at least two operating modes of a processor unit, as well as a corresponding processor having at least two integrated execution units.

### BACKGROUND INFORMATION

Such processing units having at least two integrated execution units are also known as dual core architectures or multi-core architectures. Such dual core architectures or multi-core architectures are provided mainly for two reasons in the related art.

For one thing, one is able to achieve a performance improvement using them, by regarding and treating the execution units or cores as two computing units on a semiconductor device. In this configuration, the two execution units or cores process different programs with respect to tasks. An increased performance may be achieved thereby, which is why these configurations are designated as performance mode.

The second reason for implementing a dual core architecture or multi-core architecture is an increase in security, in that the two execution units redundantly process the same program. The results of the two execution units, or CPU's, that is, cores, are compared and an error may be detected in response to the comparison for agreement. In the following, this configuration is designated as safety mode.

In general, the two configurations named are exclusively included in the dual architecture or multi-core architecture, that is, the computer having the at least two execution units is, in principle, only operated in one mode at any given time, the performance mode or the safety mode.

It is an object of the present invention to make possible a combined operation of such a dual processor unit or multi-core processor unit with respect to at least two operating types, and thereby to achieve an optimized switchover strategy, especially between a safety mode for increased safety and a performance mode for increased performance.

### SUMMARY

For safety reasons, on the one hand a redundant execution of the program with respect to tasks is desired, and for reasons of cost, on the other hand, keeping available redundant hardware during execution of the non-safety-critical functions is not worth striving for. According to the present invention, this conflict of aims is solved by an optimized switchover between at least two operating modes and one processing unit. Thus, the present invention provides a method for switching over between at least two operating modes of a processing unit having at least two execution units, as well as a processor unit.

Advantageously, the switchover from a first to a second operating mode is implemented in that one may take the opportunity of using a predefined memory address acting as switchover trigger, that is, hardware components are introduced such as switchover means (mode selector) or means of comparison and a corresponding method, as to how, in operation between safety-critical programs which are executed redundantly in the safety mode, and non-safety-critical programs which are executed in performance mode independently of one another on both execution units, one may optimally switch over.

In this context, the same programs are processed synchronously in the first operating mode by the at least two execution units, and are checked by provided means of comparison to make sure that the statuses of the execution units, created during the processing of the same programs, agree with one another. In cases of deviations in this regard, it is then conceivable to provide various error reactions, e.g., an error display, an emergency operation, and switching off the faulty unit.

In one example embodiment, the safety mode corresponds to the first operating mode and the performance mode corresponds to the second operating mode. A switchover from the second operating mode to the first operating mode expediently takes place, in this context, by an interruption request, in particular triggered by a means of interruption, the interruption request being able to be triggered, on the one hand, by a time condition or also by a status condition, that is, it corresponds to a certain status of at least one of the two execution units or to the occurrence of a certain event.

Advantageously, a special subdivision takes place in at least three separate memory regions, the execution units having access to a first memory region or a second memory region, depending on the respective operating mode, or more precisely, are connected to it. In this context, in one example embodiment, to each of the at least two execution units there is assigned a first memory region on the processor unit, to which they are connected in the first operating mode, i.e., especially the safety mode, or have access to it. In the second operating mode, both execution units have access to only a second memory region that is assigned to both execution units, or are connected to it.

Now, monitoring means, especially the switchover means themselves, are expediently provided in such a way that, in the respective operating mode, access is made only to the corresponding memory regions or the corresponding connection to the memory regions exists. This means that, in the second operating mode, the evaluation means access only the second memory region and not the first memory regions, and in the first operating mode, the access takes place only to the respective first memory regions and not to the second memory region, which is checked by the aforementioned evaluation means, and is sanctioned in possibly corresponding error reactions, such as an error report, emergency operation or switching off.

In this context, each of the three memory regions mentioned, that is, the at least two first memory regions as well as the second memory region, are provided in a separate memory module, so that at least three memory modules are available on the processor unit. Expediently, the safety-critical programs in this context are stored respectively in a first memory region, and the programs that are not critical to safety are stored in the second memory region, expediently the predefined memory address, that has the trigger function named with respect to the switchover, is included in the second memory region.

A second advantage comes about if, for the comparison of the statuses of the execution units in the first operating mode, explicit means of comparison are provided on the processor unit, and these means of comparison only function in the first operating mode, and are put out of function in response to transition into the second operating mode, so that in an operation that is non-redundant and is not critical to safety, no comparison takes place, and with that, no error reaction that might be provoked under the circumstances.

### BRIEF DESCRIPTION OF THE DRAWINGS

FIG. 1 shows an example embodiment of a processor unit according to the present invention, having at least two execution units and the hardware components according to the present invention.

FIG. 2 shows a flowchart illustrating a switchover from the safety mode to the performance mode.

FIG. 3 shows a flowchart illustrating a switchover from performance mode to safety mode.

### DETAILED DESCRIPTION

In control applications, especially in the field of motor vehicle control such as engine control, brake control or steering and transmissions, etc., but also in industrial applications such as automation or in the field of machine tools, there are generally software tasks or programs which require a redundant execution for safety reasons, in order to detect the occurrence of errors. However, such applications that are critical to safety, in addition to requiring programs that are critical to safety, may also involve software components or programs which may even be faulty, since they are not necessary for bringing about the function itself that is critical to safety, but rather produce only an additional function, e.g., a convenience function. A redundant execution is desirable for safety reasons, but for reasons of cost, keeping available redundant hardware is not worth striving for. This issue is solved, according to the present invention, by the optimized switchover between at least two operating modes of the processor unit.

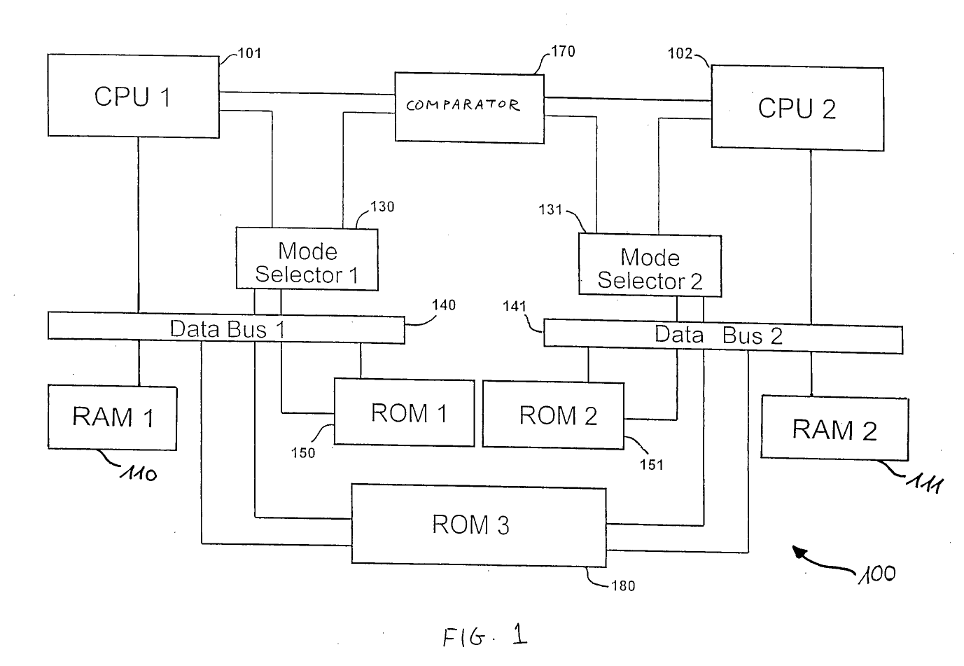

Thus, in the following, the use of the present invention in a system critical to safety is shown, for instance, a critical system in a vehicle, such as the brakes, steering, transmission or engine. The processor unit of the system, according to the present invention, is made up in this case of a dual core architecture corresponding to FIG. 1, that is, a processor unit 100 having at least two execution units 101 and 102 (CPU1 and CPU2). In this example, in each case a working memory 110 or 111, also designated as RAM1 and RAM2, is assigned respectively to the two execution units 101, 102, that is, CPU1 and CPU2.

Both execution units 101 and 102 are connected to a means of comparison, a comparator 170. Each execution unit also has a connection to a means of switching over, a mode selector 130 and 131, to which the comparison element, means of comparison 170 also has connections. The respective volatile working memory 110 and 111 and switchover means 130 and 131 are in each case connected via a bus 140 and 141, respectively, to a first storage means 150 or 151, respectively, and a second storage means 180.

In this exemplary embodiment, two operating systems are used, one for the safety-critical programs or tasks and one for the non-safety-critical programs or tasks. OSEKtime OS is used, for instance, as the operating system for the safety-critical programs, and OSEK OS is used, for instance, as the operating system for the non-safety-critical tasks.

As was already mentioned, the application software is subdivided into safety-critical programs and non-safety-critical programs. All programs or tasks that are not classified as safety-critical are allowed to fail, to be executed in a faulty manner or not to be executed at all, since a danger to the overall system or the environment is not possible. The safe operation of the overall system is only made possible by the programs or tasks that are classified as safety-critical. To be sure, the possibility exists that the operation, to the extent that it is only carried out by the safety-critical tasks or programs, leads to a quality loss of the overall function, which was classified, however, as being allowable within predefinable tolerances.

The safety-relevant, that is, the safety-critical, tasks or programs are executed redundantly on both execution units 101 and 102, that is, both CPU's CPU1 and CPU2. In this context, these programs are processed under the control of the first operating system, in this case OSEKtime OS. To do this, nonvolatile memory region is configured to two parts, so that two first memory regions 150 and 151 are present, corresponding to two execution units. In these first memory regions the safety-critical programs or tasks exist redundantly. This means that each of the safety-critical tasks is localized, first of all, in memory region 150, and secondly in memory region 151. In this context, in particular, the first operating system itself may be classified as safety-critical, and is consequently also stored in both memory regions. This means, in our example, that operating system OSEKtime OS is stored first of all in memory region 150 and secondly in memory region 151, respectively. In this context, in one example embodiment, the two first memory regions are designed as nonvolatile storage module ROM1 and ROM2, which are able to be designed as a ROM, PROM, EPROM, EEPROM, flash EEPROM, etc.

In this context, a double storing of the safety-critical programs or tasks is not absolutely necessary. They may be protected also by using an ECC code (error code and correction). Such methods for error detection in a memory are manifold, the base assumption being the protection by an error detection code or an error correction code, that is, a signature. In the simplest case, this signature may be made up of only one signature bit, such as a parity bit. On the other hand, the protection may also be implemented by complex ED codes (error detection) such as a Berger code or a Bose-Lin code, etc., or also by a more complex ECC code, such as, for instance, a Hamming code, etc., in order to make possible a safe error detection by an appropriate bit number. However, as code generator, for instance, a generator table (hardwired or in software) may also be used, in order to assign to certain input patterns of the bits a desired code pattern of any desired length within the scope of the address. The data safety in the memory is able to be ensured by this, especially by the correction function, and duplicate storage may be avoided. Nevertheless, a redundant processing of the safety-critical programs in the two execution units takes place, whereby errors are uncovered in the cores, that is, the execution units, by comparison for agreement, according to the present invention, only one first memory region being required for this example embodiment of the present invention, in contrast to the arrangement shown in FIG. 1.

In order to increase performance, the programs or tasks that are not safety-relevant or safety-critical are computed on both execution units, that is, CPU-distributed, and executed under the control of the respective operating subsystem, which in this case is the OSEK subsystem. Consequently, on each of the two execution units, there is an independent operating system, in this case an independent OSEK system. Second memory region 180, in which the non-safety-critical programs or tasks are located, is present in single form. It is used by both execution units 101 and 102, or rather, it is accessed by both. In an example embodiment, this second memory region, too, may be designed as an independent nonvolatile memory element ROM3, and realized as a ROM, PROM, EPROM, EEPROM, flash EPROM, etc.

In this context, the memory regions, that is, the first and second memory regions, may be designed in such a way that the first memory region is designed, for example, to lie between 0 and X with respect to the addresses, and the second memory region between X+1 and Y, also with respect to the addresses. In addition, a doubled first memory region is assumed, with only one single first protected memory region being able to be used, as was explained before. Then, as mentioned before, the first memory region from 0 to X is present in doubled form. In this context, each first memory region is specifically assigned to one execution unit.

In the first operating mode, in this case, for example, the safety mode, the safety-critical programs or tasks run redundantly and synchronously, on both execution units, that is, on both CPU 101 and 102. In the means of comparison, comparator 170, the respective CPU statuses are compared to each other. In this context, certain statuses are able to be assigned to certain program phases, which can then be compared at any point in time that is not critical with respect to time, provided they are stored temporarily and are uniquely assignable by an identification character. However, in an example case, the safety-critical programs, or rather tasks, are not only processed redundantly, but synchronously, so that a comparison of the respective statuses of the execution units may be performed immediately, during the operation. The new commands and/or data are then correspondingly loaded from the respectively assigned first memory region 150 or 151, and are processed. The CPU statuses are checked for agreement, an error being detected if there is a deviation in the statuses that should correspond. As the error reaction, it is first of all possible to have an error indication with respect to the respective system in which the processor unit is installed, and secondly, error reactions such as an emergency operation, that is, operating the system in which the processor unit is contained in a protected emergency operation, for instance, using extra programs and/or data provided for this purpose. In this context, even in the case of a continuing error evaluation, such as an n of m test, where n and m are natural numbers, n≧2, and M>n>m/2, or even as a 1 of k code, where k is a natural number>1. Using such a test, if, for example, one execution unit is clearly detected as being faulty, as a further error reaction, switching off this execution unit can be carried out, and an emergency operation of the remaining unit or a switchover of the faulty execution unit into emergency operation may be carried out.

In the safety mode or, more generally, the first operating mode, access of the execution units is admissible only to addresses or data in the first memory regions. This means that the respective execution unit, in the first operating mode, is permitted to access only the first memory region, especially the one that is assigned to it. This is checked by monitoring means, especially the switchover means or mode selectors 130 or 131, or rather the switchover means in mode selectors 130 and 131. If errors occur in this connection, a comparable error reaction, as described above, with respect to a comparison error based on the CPU statuses may be provided. However, this also means that the switchover means, in this case mode selectors 130 or 131, produce a connection to the respectively assigned first memory region 150 or 151 via bus 140 or 141 for this case of the first operating mode, or rather monitor a corresponding access infringement.

In the second operating mode of this exemplary embodiment, the non-safety-critical programs or tasks are processed. Various non-safety-critical programs run on both execution units, that is, CPU's 1 and 2 (101, 102). Among these are, for example, even the operating system itself for the second operating mode, namely the OSEK subsystems. The two execution units of CPU's share a nonvolatile second memory region, which may be designed as described above. However, volatile working memory region RAM1 110 or RAM2 111 is assigned to each CPU. Since such corresponding non-safety-critical programs are not, or not entirely executed in duplicate, there exists, at least theoretically, the possibility that the execution units block each other by waiting for the release of a resource. One may counter this by a suitable distribution of the tasks or programs, for instance according to scheduling on execution units 101 and 102. In this context, additional measures are also possible, such as alternating access or a prioritized access as a function of the respective program, etc. In this second operating mode, no access to an address in the first memory region is admissible according to our exemplary embodiment.

Here too, the monitoring is done by monitoring means, especially by the switchover means, the mode selectors, or perhaps the monitoring means are designed separately in the mode selectors. In response to a detected erroneous access in the second operating mode, here too, an appropriate error reaction can be initiated. In this context, first of all, an error reaction corresponding to the first operating mode is conceivable and specifiable. This is especially meaningful in that, in a faulty access, access might indeed be made, under certain circumstances, to safety-critical memory regions. On the one hand, this may be implemented in that a connection to the second memory region is established only in the second operating mode, and the connection to the first memory regions is capped in this operating mode, or access to the first memory region is prevented in another way, and is permitted only to the second memory region.

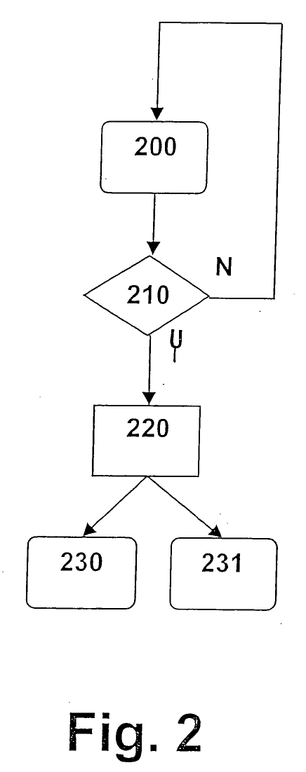

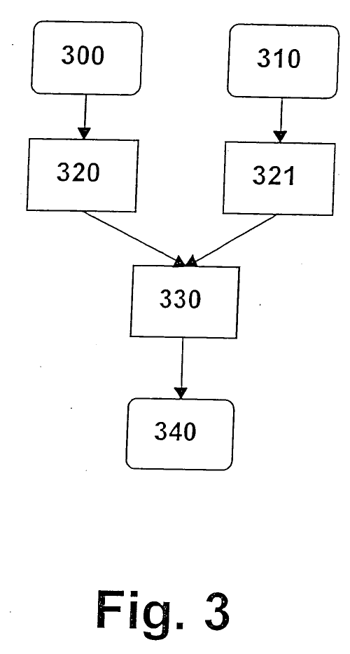

The switchover between the operating modes will now be described again in detail in FIGS. 2 and 3.

From the first operating mode, that is, in this case the safety mode, in order to get into the second operating mode, that is the performance mode in this case, access to a predefined or singular address is required, whereby a change to the second operating mode takes place. This singular address may appear, in this context, in the first memory region during the program processing, or may be supplied in an equivalent way externally. This means that in the first operating mode or safety mode, access may only be made to addresses or to a program in the first memory region; if, for instance, in this safety mode, another address is accessed, for example, in the second memory region, an error is present having a possible corresponding error reaction. In FIG. 2 this is once more made clear. In block 200, both execution units 101 and 102 are in the first operating mode, namely the safety mode. In query 210 it is checked whether the address of the next command is the same as the trigger address of the corresponding singular switchover address. If this is not the case, both processing units continue to be in the first operating mode, and consequently they access first memory regions 150, 151, respectively. However, if the address corresponds to the next command and/or datum of the trigger address, the switchover or the change to the second operating mode, i.e., the performance mode, takes place in block 220. Each execution unit also obtains, in this context, an address in the second memory region, for which processing is to be continued in the second operating mode. In this context, the comparison unit, or rather comparison means 170 is switched off, that is, it is disabled. Thus, in block 230 first processing unit 101 is in the second operating mode, and in block 231 the second execution unit 102 is also in the second operating mode, the performance mode. This says that the only possibility of getting from the safety mode to the performance mode, in this example, is, for example, to invoke a special OSEKtime task Ttrigger, such as, for instance, the ttidle task of the OSEKtime operating system, or rather an address that is included in it and designated as a trigger address, particularly the initial address of this program part or this task. This invoking occurs simultaneously in the two CPU's of necessity, in particular if the two execution units are operating synchronously. The TTrigger task as just before ttidle, in this context is for instance an invoking of the OSEK scheduler, which is in second memory region 180. This corresponding address is set as a trigger address, in order to change to the performance mode, for instance in the switchover devices, namely mode selectors 130, 131. As was said, this is checked in block 210, that is specifically in the mode selectors, the switchover means. Thus future address accesses are allowed to take place, specifically up to a renewed change into the safety mode, only into ROM region 180, namely the nonvolatile second memory region.

Now, FIG. 3 shows the switchover or the change from the performance mode back into the first operating mode, the safety mode. In block 300, execution unit 101, that is, CPU1, is in the second operating mode, the performance mode. Also, in block 310, second execution unit 102 is in just the same performance mode, this second operating mode of this exemplary embodiment. Now, in block 320 or block 321 an interrupt request is triggered for each execution unit, because of which there takes place a switchover in block 330 of both execution units 101 and 102 into the first operating mode, the safety mode. In this context, the comparison means, comparator 170 is switched on again, and in block 340, both execution units again run in the safety mode, the first operating mode. In this context, the interrupt may be triggered, on the one hand, by a time condition, that is, a time interrupt, or by a status condition or an event condition. This means that, in order to change from the performance mode to the safety mode, an interrupt of the first operating system OSEKtime is generated. This time interrupt of the OSEKtime operating system, which has higher priority than the OSEK operating system, is programmed in the same way in both CPU's, since the same OSEKtime system runs on both CPU's. The interrupt request is received at the same time at both CPU's, especially in synchronously running OSEKtime systems. As was mentioned before, this gives the OSEKtime scheduler interrupt a very high, in particular the highest priority, according to the definition. In the case of synchronicity, both interruption requests are accordingly executed simultaneously. As has also been mentioned before, using executions of these interruption requests, comparison means 170 are also put back into functioning, that is, switched over into the first operating state, the safety mode, and the execution units run redundantly.

Besides the already named timer interrupt, a status interrupt or an event interrupt may also be used, in order to manage the operating mode change, that was mentioned, from the second to the first operating mode. In this context, a certain status of the execution units can, for example, trigger a high priority interrupt, which is then valid for both execution units. This may be, for example, a status generated by the processing of the programs in ROM 180 in a CPU, which triggers such a high priority interruption request that applies also for the second CPU. An event, e.g., an event supplied from externally to the processing unit, is also able to trigger such an interrupt, and therewith trigger the operating mode change.

In the above description, an optimized switchover between two operating modes of a processor unit having two integrated execution units has been described in connection with the exemplary embodiments, which are not limiting with regard to the subject matter of the present invention.

1-28. (canceled)

29. A processor system, comprising:
at least two execution units;
a memory; and
a switch-over unit for switching between at least two operating modes of the processor system, wherein a transition from a first operating mode to a second operating mode of the processor system is triggered by accessing of a predefined memory address.

30. The processor system as recited in claim 29, further comprising:
a comparator unit, wherein the first operating mode corresponds to a safety mode in which the two execution units redundantly process the same program, and the comparator compares statuses of the two execution units resulting from processing of the same program to determine whether the statuses agree.

31. The processor system as recited in claim 30, wherein the two execution units synchronously process the same program in the first operating mode.

32. The processor system as recited in claim 29, wherein the memory includes at least a first, second and third separate memory regions, and wherein in the first operating mode, each execution unit is connected to a respective corresponding area of the first memory region assigned to each execution unit.

33. The processor system as recited in claim 29, wherein the memory includes at least a first and second separate memory regions, and wherein in the second operating mode, the two execution units are both connected to only the second memory region of the memory assigned to both execution units.

34. The processor system as recited in claim 33, wherein the predefined memory address is located in the second memory region.

35. The processor system as recited in claim 29, wherein the memory includes at least a first and second separate memory regions, and wherein in the first operating mode, the two execution units are both connected to only the first memory region of the memory assigned to both execution units.

36. The processor system as recited in claim 35, wherein the predefined memory address is a trigger address in the first memory region, and wherein a following address, to which access is to be subsequently made, is included in the second memory region.

37. The processor system as recited in claim 33, wherein the switch-over unit functions as a monitoring unit for monitoring whether the two execution units are connected in the second operating mode only to the second memory region.

38. The processor system as recited in claim 32, wherein the switch-over unit functions as a monitoring unit for monitoring whether the two execution units are connected in the first operating mode only to the respective corresponding areas of the first memory region.

39. The processor system as recited in claim 33, wherein each of the memory regions is provided in a separate memory module.

40. The processor system as recited in claim 30, wherein the comparator is switched off in response to the transition into the second operating mode, and wherein the second operating mode is a performance mode, and wherein a comparison of the statuses of the two execution units takes place only in the first operating mode.

41. The processor system as recited in claim 29, wherein an interrupt is generated to enable a subsequent return to the first operating mode from the second operating mode.

42. The processor system as recited in claim 41, wherein the interrupt is triggered by a time condition.

43. The processor system as recited in claim 41, wherein the interrupt is triggered by a status condition.

44. A method for switching between at least two operating modes of a processor system having at least two execution units and a memory, comprising:
triggering a transition from a first operating mode to a second operating mode of the processor system by the processor system accessing a predefined memory address in the memory.

45. The method as recited in claim 44, wherein in the first operating mode, the execution units redundantly and synchronously process the same program.

46. The method as recited in claim 44, wherein different programs are processed in the first and second operating modes, a safety-critical program being redundantly processed by both execution units in the first operating mode, and non-safety-critical programs being processed in the second operating mode.

47. The method as recited in claim 46, wherein the safety-critical program is redundantly stored in respective memory areas of the first memory region assigned to the two execution units.

48. The method as recited in claim 46, wherein the non-safety-critical programs are stored in the second memory region, and wherein both execution units only access the second memory region in the second operating mode.

49. The method as recited in claim 44, wherein in the first operating mode, the safety-critical program is redundantly processed by the two execution units, and statuses of the two execution units resulting from redundant processing of the safety-critical program are compared for agreement.

50. The method as recited in claim 44, wherein in the first operating mode, the execution units only access respective memory areas of the first memory region assigned to each execution unit.

51. The method as recited in claim 44, wherein the memory includes at least a first and second separate memory regions, and wherein in the first operating mode, both execution units access only the first memory region assigned to both execution units.

52. The method as recited in claims 51, wherein the predefined memory address is a trigger address in the first memory region, and wherein a following address, to which access is to be subsequently made, is included in the second memory region.

53. The method as recited in claim 44, wherein the memory includes at least a first and second separate memory regions, and wherein in the second operating mode, the two execution units only access the second memory region assigned to both execution units.

54. The method as recited in claim 53, further comprising:
monitoring whether the two execution units are only accessing the second memory region in the second operating mode.

55. The method as recited in claim 51, further comprising:
monitoring whether the two execution units are only accessing the first memory region in the first operating mode.

56. The method as recited in claim 44, further comprising:
triggering an interrupt based on one of a time condition and a status condition, wherein a transition from the second operating mode to the first operating mode takes place upon triggering of the interrupt.
